(19) United States
(12) Patent Application Publication
(10) Pub. No.: US 2009/0158492 A1
(43) Pub. Date: Jun. 25, 2009

(54) QUICK-DRYING TEXTILE

(76) Inventor: Min Yao, Vernon Hills, IL (US)

Correspondence Address: Nixon Peabody LLP, 161 North Clark Street, 48th Floor, Chicago, IL, 60601, US

(21) Appl. No.: 12/337,362

(22) Filed: Dec. 17, 2008

Related U.S. Application Data
(60) Provisional application No. 61/008,718, filed on Dec. 21, 2007.

(51) Int. Cl. A41D 13/12; B32B 5/02; A41D 1/00; A47G 9/02

(52) U.S. Cl. 2/83; 442/59; 2/114; 2/69; 2/93; 5/482; 5/499; 5/495; 5/490

(57) ABSTRACT

A quick-drying textile includes a fabric and a chemical applied to the fabric. The chemical modifies the fabric's absorption properties.

### CROSS-REFERENCE TO RELATED APPLICATION

This application claims the benefit of U.S. Provisional Patent Application No. 61/008,718, filed Dec. 21, 2007 entitled “Quick-Drying Textile”, which is hereby incorporated by reference in its entirety.

### FIELD OF THE INVENTION

The present application relates generally to textiles. More particularly, the present invention relates to an energy efficient textile.

### BACKGROUND

According to the Textile Rental Service Association of America, a facility annually handling 25 million pounds of laundry at 2.75 therms per 100 pounds (assuming a cost of $1.2/therm) will spend approximately $825,000 per year on energy. See “Knowledge is Power—A Look at Energy Saving Equipment Options Knowing What You Use and Acting to Conserve Could Save you Thousands” by A. Jenneman, Textile Rental Service Association of America, http://www.trsa.org/.h2e/Power.asp (last visited Dec. 20, 2007).

Approximately 65% of the total energy consumed in handling laundry is attributable to the process of drying wet laundry. See “Case Study: Energy Efficient Technology May 2007,” http://www.eecabusiness.govt.nz/eib/case-studies/documents/cls-07.pdf (last visited Dec. 20, 2007). Reducing the energy consumed in drying wet laundry by 10% yields total energy reductions approximating 44,687 therms and savings of $53,625 annually (assuming a facility handling 25 million lbs/yr at 2.75 therms/lb and $1.2/therm).

The general approach to reducing energy consumption is to design, build, and implement superior energy efficient drying machines. However, technological hurdles and the necessity of retooling laundry facilities with new machines makes this approach cost prohibitive on a large scale. A low-cost alternative can be achieved by decreasing the time required to dry each load of wet laundry. As an additional benefit, reducing the drying time for each load of wet laundry requires less labor to operate laundry facilities. Moreover, the EPA estimates that burning one therm of gas can produce 12 pounds of carbon dioxide. See “EPA's State And Local Climate Change Program,” http://yosemite.epa.gov/oar/GlobalWarming.nsf/UniqueKeyLookup/SHSU5BVPVS/$File/sci enceactivities.pdf (last visited Dec. 20, 2007). The same 10% reduction in drying energy described above reduces total carbon emissions by approximately 536,250 pounds annually. Therefore, a need exists for a fabric which can be dried faster requiring less energy.

A load of wet laundry weighing 130 kg contains approximately 65 kg (50%) of water, which must be evaporated before the laundry is considered “dry” and can be moved to other processing steps such as ironing or folding. Thus, drying time and energy can be reduced by reducing the amount of water to be evaporated for each load of laundry. One could simply use textiles with inherently low absorption properties, however, often times the intended use of the textile—such as towels for soaking up water or other liquids—requires high absorption properties. Therefore, a need exists for a textile that maintains the absorption properties desired for its intended use, yet is capable of energy efficient laundering due to quick-drying properties.

### BRIEF DESCRIPTION OF THE DRAWINGS

The advantages of the invention will become apparent upon reading the following detailed description and upon reference to the drawings.

FIG. 1 diagrams a temperature sensitive polymer bonded to fiber at room temperature.

FIG. 2 diagrams a temperature sensitive polymer bonded to fiber at high temperature.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention.

### DESCRIPTION OF ILLUSTRATIVE EMBODIMENTS

A quick-drying textile is made by applying, treating, or coating a fabric with a chemical to modify the absorption properties of the fabric. The fabric may be made from natural fiber materials (e.g., cotton, wool fiber, silk fiber, cellulosic fiber, regenerated cellulosic fiber), synthetic fiber materials (e.g., polyester, polyamide, polypropylene), and/or blends or combinations thereof. Fabrics or fabric blends having high absorption properties will benefit most from the application of the chemical described herein. It is contemplated that the quick-drying textile may be, but is not limited to, towels, rags, cloths, uniforms, lab coats, patient wears, bedspreads, blankets, mattress pads, sheets, pillowcases, or washcloths. It is contemplated that these quick-drying textiles may be desirable for laundering facilities in a variety of settings such as, but not limited to, hospitals, nursing homes, hotels, industrial launders, penitentiaries, or schools.

According to one embodiment, the chemical applied to the fabric facilitates a more uniform distribution of moisture throughout the fabric. The chemical may be a surfactant, which lowers the surface tension of liquids and forms a moisture transfer channel throughout the fabric to facilitate moisture transfer throughout the fabric. Surfactants or softeners suitable for application to the quick-drying textile described herein can be cationic surfactants (e.g., quaternary ammonium-based surfactants), anionic surfactants (e.g. sulfonate-based surfactants), non-ionic surfactants (e.g., ethoxylated-based, silicon-based and polyurethane-based surfactants) and/or combinations thereof. It is contemplated that the chemical applied to the fabric may be a single chemical or a plurality of chemicals that when combined are suitable to distribute moisture throughout the fabric.

In a typical drying process, some portions of fabric may be more directly exposed to heat sources than other portions. Generally, more directly exposed portions become dry faster than indirectly or less directly exposed portions. Accordingly, untreated fabrics may have portions that become completely dry long before other portions, thus, requiring extra time and energy to completely dry the untreated fabrics. However, according to embodiments where a chemical such as a surfactant is applied to the fabric, a more efficient drying process is achieved by minimizing the disparity of moisture concentrations within various portions of the fabric. When portions of the quick-drying textile become drier faster than other portions, the chemical may cause some moisture to be transferred from the wetter portions to the drier portions of the quick-drying textile. By more uniformly distributing moisture throughout the fabric, the entire fabric becomes substantially dry at approximately the same time, saving both time and energy.

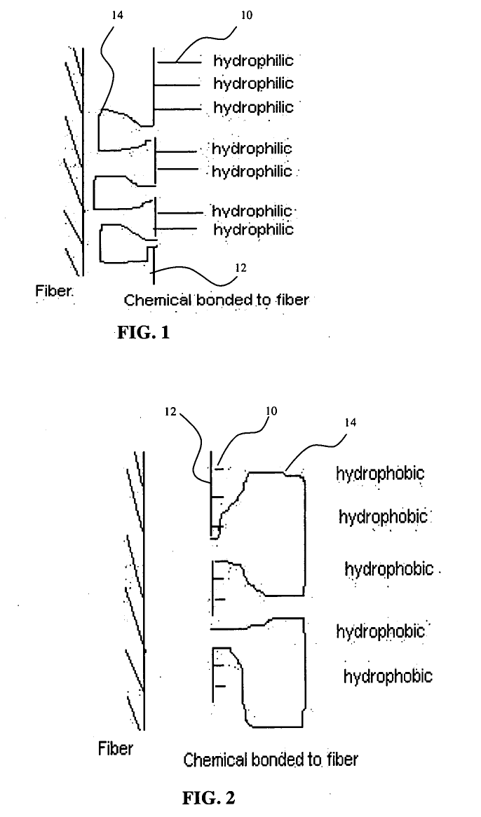

According to an alternative embodiment, the chemical applied to the fabric affects the absorption properties of the fabric depending on the chemical's temperature. The chemical(s) may be hydrophilic (i.e., moisture absorbent) at a first temperature and hydrophobic (i.e., moisture repellant) above or below a second temperature. The first temperature may be room temperature. Referring to FIG. 1, at the first temperature, the hydrophilic portions 10 of the chemical(s) substantially cover the surface of the fiber 12, while the hydrophobic portions 14 remain beneath the surface of the fiber 12. Thus, at the first temperature, the fibers will exhibit hydrophobic properties. Referring to FIG. 2, above or below the second temperature, the hydrophilic portions 10 shrink, while the hydrophobic portions 14 expand to the fabric surface 12. Thus, above or below the second temperature, the fibers will exhibit hydrophobic properties. If the chemical subsequently returns to the first temperature, the fibers will again exhibit hydrophilic properties. It is contemplated that the first temperature may be a range of first temperatures (e.g., 0° C. to 50° C.). It is further contemplated that a chemical can be considered to be hydrophilic, for example, when the hydrophile lipophile balance (HLB) of the chemical is greater than or equal to ten (10). However, it should be understood that the embodiments described herein are not intended to be limited in this regard and any other suitable value of hydrophile lipophile balance may be used to define whether the chemical is hydrophilic or hydrophobic at a given temperature.

The chemical(s) applied to the fabric of the quick-drying textile are temperature sensitive. The chemical(s) exhibit varying degrees of hydrophilic and hydrophobic properties based on temperature. The desired degree of hydrophilicity and/or and hydrophobicity of the chemical(s) selected to be applied to the fabric of the quick-drying textile may vary based on factors such as, for example, fiber content, intended use of the quick-drying textile, and cost. It is contemplated that the chemical(s) applied to the fabric may be a single chemical or a plurality of chemicals that when combined are suitable to exhibit hydrophilic or hydrophobic properties depending on the chemical(s) temperature.

One nonlimiting example of a chemical suitable to be applied to the fabric of the quick-drying textile is poly(N-isopropylacrylamide). The polymer poly(N-isopropylacrylamide) is also referred to as poly(NIPAM). The chemical structure of poly(N-isopropylacrylamide) is

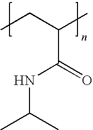

Poly(NIPAM) has a hydrophobic polymer chain and a hydrophilic side chain. When the temperature is below the lower critical solution temperature (i.e., the second temperature), poly(NIPAM) is hydrophilic. When the temperature is above the lower critical solution temperature, poly(NIPAM) is hydrophobic.

Another nonlimiting example of a chemical suitable to be applied to the fabric of the quick-drying textile is a co-polymer of ethylene oxide and propylene oxide. For example, the chemical may be an EOxPOyEOz co-polymer where EO is ethylene oxide and PO is propylene oxide. The structure of an EO PO EO co-polymer is

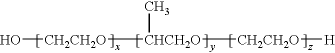

A third nonlimiting example of a chemical suitable to be applied to the fabric of the quick-drying textile is Sartech QD®, which includes (2-methoxymethylethoxy)propanol. Sartech QD® is commercially available from Peach State Labs, Inc., which is currently headquartered at 180 Burlington Road, Rome, Ga. 30162.

A fabric treated or coated with the chemicals described herein may exhibit hydrophilic properties at room temperature and hydrophobic properties above a threshold temperature such as, for example, 50° C. (i.e., 122° F.). Room temperature is the temperature of a room where people normally live and/or work. As a nonlimiting example, room temperature may be about 18° C. to about 25° C. (i.e., about 64° F. to about 77° F.). At room temperature, the fabric will be hydrophilic and will have absorption properties similar to those of an untreated fabric made of the same fiber materials. Washing the fabric in hot water increases the temperature of the fabric and the chemical. When the chemical is heated above the threshold temperature (i.e., the second temperature or lower critical temperature), the chemical applied to the fabric causes the fabric to exhibit hydrophobic properties. The hydrophobic fabric lacks affinity for and tends to repel water. Therefore, additional water applied to the fabric may not be absorbed and some water previously absorbed may be expelled. The expulsion of water from the fabric results from the moisture's inability to cling to the fibers of a hydrophobic fabric in motion. Thus, compared to an untreated fabric, the fabric of the quick-drying textile described herein contains less water to be evaporated at the end of a wash cycle using water above a threshold temperature.

Even if the fabric is washed in water below the threshold temperature, the fabric is exposed to heat in the drying process. Once the fabric and chemical are heated to or above the threshold temperature, the chemical causes the fabric to exhibit hydrophobic properties. Again, the hydrophobic fabric lacks affinity for and tends to repel moisture. As the fabric is tumbled by the drying machine, some moisture may be unable to cling to the fibers of the hydrophobic fabric. The removed moisture may be drained out of the dryer or evaporated faster due to direct exposure to the drying machine's heat source. As a result, less water remains to be evaporated within the fabric of a quick-drying textile compared to an untreated fabric made from the same fiber materials. Therefore, it will take less time and energy to dry fabrics treated with a chemical according to this implementation.

### Verification of Improved Drying Efficiency

A test was performed to verify the improved efficiency of the quick-drying textiles. Four identical cotton terry fabric towels measuring 22 inches by 29 inches were selected for the test. Two towels were treated with a chemical that affects the absorption properties of the towels depending upon the temperature of the towels and two towels were left untreated to serve as control towels. The chemical used in this test was Sartech QD®, which includes (2-methoxymethylethoxy)propanol. The chemical was applied using a dip-pad-dry-cure process. First, the towel was wet in a bath containing Sartech QD®. The wet towels were then padded with pad rolls set at approximately 30 pounds per square inch (psi) to provide 100% wet pick-up of the treating bath. The padded treated towels were stretched on a frame. Next, the towels were dried and cured by heating for forty-five seconds at 170° C. (i.e., 338° F.) in a forced-draft oven. The towels were then conditioned at least 1 hour at room temperature prior to testing.

Each of the four towels was weighed and it was determined that the average dry weight of both the treated and untreated towels was 0.215 kilograms (kg). All four towels were then washed for nine minutes in water at a temperature of about 43° C. (i.e., about 110° F.). This water temperature was selected to sufficiently raise the temperature of the treated towels above the threshold temperature of Sartech QD®. After the wash cycle, it was determined that the average weight of the untreated towels was 0.365 kg and the average weight of the treated towels was 0.348 kg. Thus, the untreated towels retained an average of 0.150 kg of water and the treated towels retained an average of 0.133 kg of water. The 0.017 kg of water weight difference between treated and untreated towels corresponds to an 11.3% reduction in water retention when washed in water at a temperature above the critical temperature of the chemical used on the treated towels. Therefore, even if the towels were never mechanically dried, the treated towels in this test should become dry approximately 11.3% faster than the untreated towels.

The towels were subsequently mechanically dried. One untreated towel and one treated towel were placed in separate mechanical driers operating at a temperature of about 49° C. (i.e., about 120° F.). The other two towels were placed in separate mechanical driers operating at a temperature of about 82° C. (i.e., about 180° F.). Each of the towels was periodically removed from the drier and weighed. A towel was considered to be “completely dry” when it reached its initial dry weight of 0.215 kg. In a drier machine operating at about 49° C., the untreated towel required approximately 25 minutes to completely dry and the treated towel required approximately 20 minutes to completely dry. Thus, approximately 20.0% less time was required to completely dry the treated towel at 49° C. In a drier machine operating at about 82° C., the untreated towel required approximately 14 minutes to completely dry and the treated towel required approximately 12.5 minutes to completely dry. Thus, approximately 10.8% less time was required to completely dry the treated towel at 82° C.

It is contemplated that the chemical treatments described herein may remain effective after multiple laundry cycles. As described above, the chemical may be applied to the fabrics using a dip-pad-dry-cure process with a binding agent added to the bath to enhance the durability of the chemical treatment. Nonlimiting examples of suitable binding agents include polyacrylic-based, polyurethane-based or silicon-based binders and/or combinations thereof. In other illustrative examples, the chemical may be applied by kiss roll, spray, or foaming blade. However, it is contemplated that any treatment technique suitable to apply the chemicals to fabric fibers, as described herein, may be employed.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the invention, which is set forth in the following claims.

What is claimed is:

1. A quick-drying textile comprises:
a fabric exhibiting a first liquid absorption property at a first temperature; and
a chemical applied to the fabric, the chemical modifying the absorption properties of the fabric such that the fabric exhibits a second liquid absorption property at a second temperature.

2. The quick-drying textile of claim 1, wherein the second temperature is greater than the first temperature.

3. The quick-drying textile of claim 1, wherein the first temperature is room temperature.

4. The quick-drying textile of claim 1, wherein the second temperature is any temperature greater than approximately 50° C.

5. The quick-drying textile of claim 1, wherein the second liquid absorption property is less than the first liquid absorption property.

6. The quick drying textile of claim 1, wherein the first liquid absorption property is hydrophilic property and the second liquid adsorption property is hydrophobic property.

7. The quick-drying textile of claim 1, wherein the fabric is made from natural fiber materials, synthetic fiber materials, or blends thereof.

8. The quick-drying textile of claim 1, wherein the chemical includes (2-methoxymethylethoxy)propanol.

9. The quick-drying textile of claim 1, wherein the chemical includes at least one of poly(N-isopropylacrylamide) and a co-polymer of ethylene oxide and propylene oxide.

10. The quick-drying textile of claim 1, wherein the quick-drying textile is a medical product.

11. The quick-drying textile of claim 10, wherein the medical product is one of a towel, a rag, a cloth, a uniform, a lab coat, a garment for a patient, a bedspread, a blanket, a mattress pad, a sheet, a pillowcase and a washcloth.

12. A method for manufacturing a quick-drying textile, the method comprising:
providing a fabric; and
treating the fabric with a chemical such that the chemical reduces the liquid absorption property of the fabric when the fabric is heated.

13. The method of claim 12 further comprising the step of adding a binding agent to the chemical before treating the fabric.

14. The quick-drying textile of claim 12, wherein the chemical includes (2-methoxymethylethoxy)propanol.

15. The quick-drying textile of claim 12, wherein the chemical includes one or more of poly(N-isopropylacrylamide) and a co-polymer of ethylene oxide and propylene oxide.

16. A quick-drying textile comprises:
a fabric; and
a chemical applied to the fabric, the chemical causing the fabric to distribute moisture in a substantially uniform concentration throughout the fabric.

17. The quick-drying textile of claim 16, wherein the chemical is a surfactant.

18. A method for manufacturing a quick-drying textile, the method comprising:
providing a fabric; and
treating the fabric with a chemical such that the chemical causes the fabric to distribute moisture in a substantially uniform concentration throughout the fabric.

19. The method of claim 18 further comprising the step of adding a binding agent to the chemical before treating the fabric.
